(19) United States
(12) Patent Application Publication
(10) Pub. No.: US 2016/0342727 A1
(43) Pub. Date: Nov. 24, 2016

(54) METHOD AND SYSTEM FOR CHECKING AND CORRECTING SHOOT-THROUGH IN RTL SIMULATION

(71) Applicant: Synopsys, Inc., Mountain View, CA (US)

(72) Inventors: Mohamed Shaker Sarwary, San Diego, CA (US); Paras Mal Jain, Greater Noida (IN); Anshu Malani, Hisar (IN)

(73) Assignee: Synopsys, Inc., Mountain View, CA (US)

(21) Appl. No.: 14/716,422

(22) Filed: May 19, 2015

(51) Int. Cl. G06F 17/50

(52) U.S. Cl. CPC G06F 17/5081; G06F 17/5009

(57) ABSTRACT

In a method of checking an integrated circuit design prior to running a simulation, a shoot-through RTL Checker reads RTL design files, uses a simulator delta cycle definitions to compute clock delta delays, and helps to correct and report any conditions that are expected will cause the simulation to generate incorrect results, in particular shoot-through conditions at circuit memory elements such as source and destination flip-flops or registers.

### TECHNICAL FIELD

This invention relates to the field of integrated circuit design verification and in particular to simulation of an integrated circuit design. More particularly the invention relates to a system, method and computer program product for computing clock path delta delays and reporting conditions that will cause the simulation to generate incorrect results.

### BACKGROUND ART

Electronic chip designers frequently simulate Register-Transfer-Level (RTL) designs with little or no timing information. Silicon signals have propagation delays so the simulation result may differ from actual silicon behavior. This difference of behavior can lead to a real functional bug being missed in simulation. It can also lead to simulation failures in an otherwise valid design that are time-consuming to diagnose. Many of these differences are due to incorrect estimation of propagation time between clock and data paths causing a data to be propagated earlier than it would in actual silicon. This problem is known as a shoot-through situation in simulation.

Most modern electronic chip designs have power budgets. Electronic chip designers manage the power by introducing lower-frequency, divide-by-N clocks in the design and by gating clocks. This introduction of logic in the clock path can cause race conditions and complicates timing verification.

Consider the VHDL signal-assignment statements or the corresponding Verilog non-blocking assignment statements:

A<=B;

C<=A;

Under normal circumstances with a common clock, signal C will be assigned the old-value of A and A will be assigned the value of B. Simulators evaluate the expressions on the right hand side of the assignment operator and then assign the values to the variables on the left hand side an infinitesimally small time later. This interval between evaluation and assignment is called a delta-delay.

Simulators add delta-delays for various types of constructs (e.g. assignments) in a RTL description. These delta-delays are not always predictably added and they differ from one simulator to another. This would not be a problem if all the paths of a clock contained an equal number of delta-delays, but in practice, this is not always the case. We may end up with a situation where a flop is clocked one or more delta cycles earlier than another flop. This results in a shoot-through situation, where data is passed from the early clocked flop (source) to the late clocked flop (destination).

Designers are often confused by these types of simulation errors and can spend a long time debugging them. Designers frequently try to solve these problems by balancing the clock tree. They try to insert buffers in different clock paths so that each clock path has the same delta-delay. This is often a difficult and time-consuming task.

Designers would benefit from having a tool that accurately reports and helps correct conditions causing the simulation to generate incorrect results. Designers want such a tool to provide an easy means for solving the problems.

### SUMMARY DISCLOSURE

A shoot-through RTL Checker reads RTL design files, uses a simulator delta cycle definition, computes clock delta delays, reports and helps correct conditions that will cause the simulation to generate incorrect results. In particular, a method for checking simulation timing errors of an electronic circuit design reads one or more design files, reads or determines simulator delta cycle delays, identifies source and destination memory elements, analyzes the number of delta delay cycles between clock sources and memory element clock pins, optionally computes the data path delays if so directed by the user, and based on the delta delay analysis on clock path reports conditions that will cause RTL simulation to generate incorrect results. The design files are then corrected to avoid the reported conditions.

A method and corresponding system for checking an integrated circuit design by identifying and correcting in advance expected shoot-through behavior of a circuit simulator in accord with the present invention is implemented as RTL checker software running on a computer system. The system comprises a computer processor having access to data storage and user-interactive input/output devices, wherein the data storage stores the RTL checker software and also preferably simulator delta cycle definitions corresponding to one or more circuit simulators. When executed by the computer processor, the RTL checker software is operative to receive, by a data storage accessible to a processor, a circuit register-transfer-level (RTL) description of at least a portion of an integrated circuit design to be run on a specified simulator. The RTL description is analyzed by the processor to determine numbers of delta delay cycles for clock and data paths of the circuit design when run on the specified simulator. Preferably, this may be done by using delta cycle definitions of the specified simulator retrieved by the processor from the data storage. Next, the processor identifies, from the determined delta delay cycles and according to rules designated in the RTL checker software, any conditions in the circuit design expected to produce shoot-through behavior when run on the specified simulator. Any such identified conditions are reported to at least one of the data storage and to a user-interactive input/output device, and the RTL description is corrected as needed based on the reported conditions, the corrected description being saved in data storage for running on the specified simulator. The corrections may be performed automatically by the processor in response to the identifying of a condition of expected shoot-through behavior, and then preferably the automatic correction would be displayed on the user-interactive input/output device for confirmation or rejection by a user.

Conditions of expected shoot-through behavior are determined by first identifying any interacting source and destination memory elements in the circuit design, determining whether there is a difference of clock path delays between those two memory elements, and then determining whether an after/# clause assignment statement specifying an explicit delay is absent in a data path of the source memory element. In this case the correction would introduce the absent after/# clause assignment statement into the data path of the source memory element. Likewise, if an after/# clause assignment statement specifying an explicit delay is found to be present in a clock path of either source memory element, the correction would be to remove such statement from the determined clock paths. If any clock divider is found to be present after a common clock point for both source and destination memory elements, and if it is also determined there is a non-zero delay for the clock path to the destination memory element that is absent in the clock path to the source memory element producing a delta delay from the common clock point, then an appropriation correction would add an after/# clause assignment statement specifying an explicit delay corresponding to the non-zero delay to the clock path for the destination memory element. Also, shoot-through behavior would be expected for memory elements in a circuit design that are connected to an output port if it is determined that an after/# clause assignment statement specifying an explicit delay is absent in a data path of that memory element. If desired, a user may be allowed to specify that certain data paths should not be checked, but instead ignored.

### BRIEF DESCRIPTION OF THE DRAWINGS

FIG. 1 shows an RTL design with corresponding waveforms showing shoot-through.

FIG. 2 shows the synthesized result of the RTL design with corresponding waveforms without shoot-through.

FIG. 3 shows the corrected RTL design with corresponding waveforms without shoot-through.

FIG. 4 shows a flowchart outlining the steps of the shoot-through RTL Checker.

FIG. 5 shows a block diagram of a shoot-through RTL Checker.

### DETAILED DESCRIPTION

A shoot-through RTL Checker (STC) reads RTL design files, uses a simulator delta cycle definition, computes clock path delta delays, reports and helps correct conditions that will cause the simulation to generate incorrect results. The STC uses the simulator delta cycle definition to understand how a specific version of a simulator inserts delta delays. The STC recommends using delayed assignments in the data path where necessary to solve the simulation problem. The STC analyzes each clock source in turn, looking for pairs of connected memory elements driven by that same clock source. The STC reports a shoot-through simulation error if the following conditions are true:
a) The clock path of the source memory element has less delay than that of the clock path of the destination memory element;
b) The designer has not indicated that these components or nets should be ignored by specifying an explicit delay (e.g., by adding an after clause in the RTL); and
c) The designer has specified that the clock path delay difference should be compared to the data path delay and the difference in clock path delay is greater than the delay in the data path between the memory elements.

In addition the STC reports any explicit delay present on the clock paths to the user. This is because such uncommon practice would create further opportunity for erroneous simulation mismatches that should be avoided. The reported error will be fixed manually, semi-automatically or fully-automatically. In one embodiment, the STC automatically modifies the RTL design files to remove explicit delays on the clock paths.

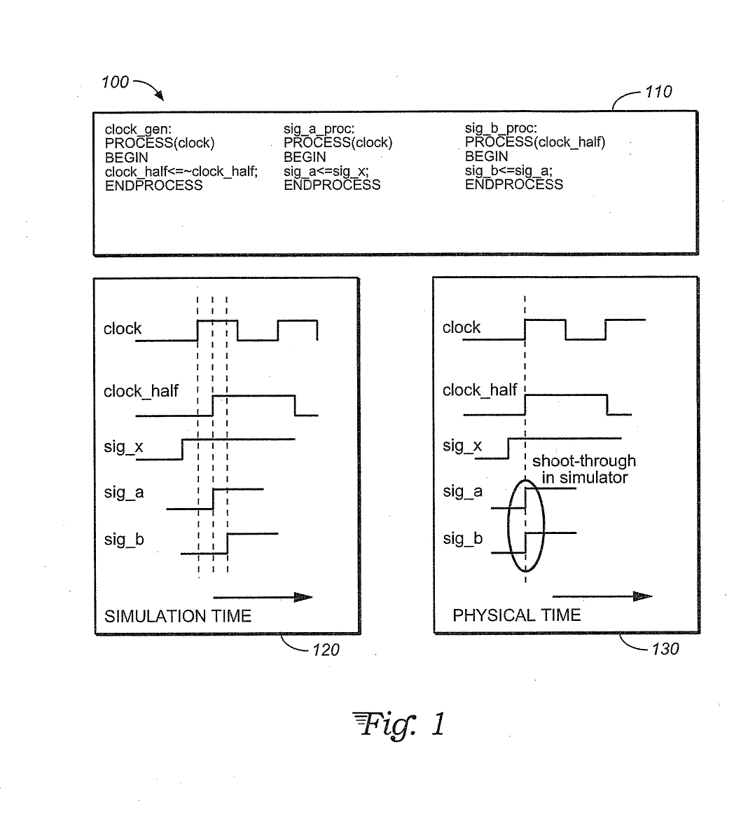

FIG. 1 is a diagram 100 showing RTL code 110 and corresponding simulation waveforms 120 and 130. Simulation waveform 120 shows waveform transitions with respect to simulation time increments and helps explain the simulator behavior. Simulation waveform 130 shows waveforms transitions with respect to physical time increments. Simulation waveform 120 shows the infinitesimally small delta delays whereas simulation waveform 130 does not. Simulation waveform 130 is the waveform seen by an electronic designer. The RTL code 110 shows three concurrent processes called clock_gen, sig_a_proc and sig_b_proc. The first process clock_gen in 110 creates a divide-by-2 clock signal called clock half. The clock gen process inverts the value of the clock half signal on each rising edge of the signal clock. Simulation waveform 120 shows the signal clock oscillating between low to high values. Simulation waveform 120 shows the signal clock_half oscillating with half the frequency of the signal clock. In simulation waveform 120 the signal clock_half has its value inverted at a delta-delay time after the signal clock transitions from low to high. The simulator inserts a delta-delay before making the assignment to signal clock_half.

The second process sig_a_proc in 110 assigns the value of signal sig_x to signal sig_a and depends on the rising edge of signal clock. Simulation waveform 120 shows signal sig_a transitioning from low to high when it is assigned the value of signal sig_x. Simulation waveform 120 shows signal sig_a is assigned the new value at a delta-delay time after the signal clock transitions from low to high.

The third process sig_b_proc in 110 assigns the value of signal sig_a to signal sig_b and depends on the rising edge of signal clock_half. Simulation waveform 120 shows signal sig_b transitioning from low to high when it is assigned the value of signal sig_a. Simulation waveform 120 shows signal sig_b is assigned the new value at a delta-delay time after the signal clock_half transitions from low to high. Signal sig_b is assigned the new value of sig_a because it uses the value of sig_a evaluated on the rising edge of signal clock_half.

Simulation waveform 130 shows the simulation results with respect to physical time increments as seen by an electronic designer. In simulation waveform 130 the electronic designer sees signal sig_b transition at the same time as signal sig_a and sees signal sig_b being assigned the new value of signal sig_a.

Since non-blocking assignments can trigger additional steps in the same time cycle, the change in sig_a can be captured by sig_b in the same clock cycle. This issue is happening because of the task scheduling sequence during simulation. In VHDL, this problem occurs because of delta delays and in Verilog, this occurs because of “non-blocking assignment can further trigger blocking/non-blocking assignment”.

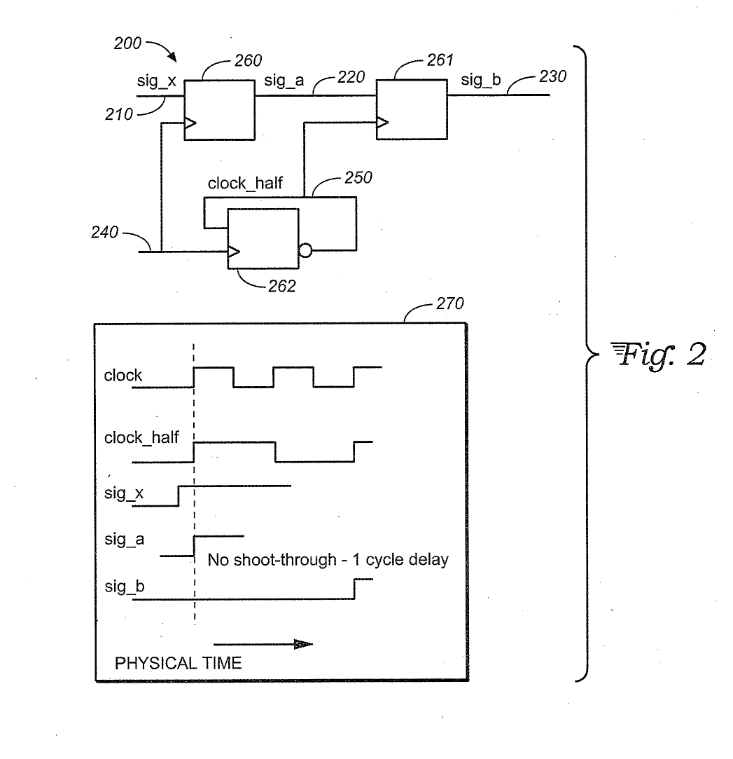

FIG. 2 is a diagram 200 showing a synthesized design derived from the RTL 110 and the waveform corresponding to the synthesized design 270. Register 262 receives signal clock 240 and generates signal clock_half 250. Register 260 receives data input signal sig_x 210 and signal clock 240. Register 260 outputs signal sig_a 220 that drives the data input of register 261. Register 261 is controlled with clock signal clock_half 250 and outputs signal sig_b 230. The waveform 270 shows signals clock, clock_half, sig_a and sig_b assume new values at the same time. On the first clock edge signal sig_b 230 assumes the previous value of sig_a 220 which is low. On the second clock edge signal sig_b 230 assumes the previous value of sig_a 220 which is high.

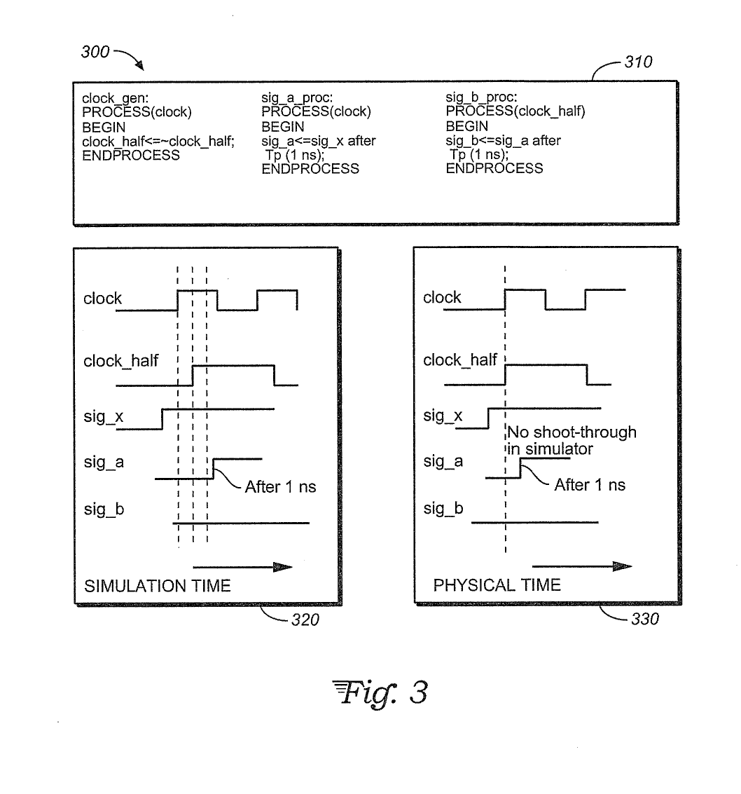

FIG. 3 is a diagram 300 showing the same RTL design with delayed assignment statements. In RTL 310 processes sig_b_proc and sig_b_proc have after clauses in their assignment statements. VHDL uses after clauses to indicate delayed assignment and Verilog use #delay clauses. These delayed assignment statements tell the simulator to delay assignment by the specified interval of ins. In simulation waveform 320 signal sig_a is assigned a value ins after the rising edge of the signal clock. In simulation waveform 320 signal sig_b is assigned a value ins after the rising edge of the signal clock_half. Signals sig_a and sig_b receive the values determined at the clock edge. Signal sig_b will be assigned the old value of sig_a because the value of sig_a isn't changed until ins later.

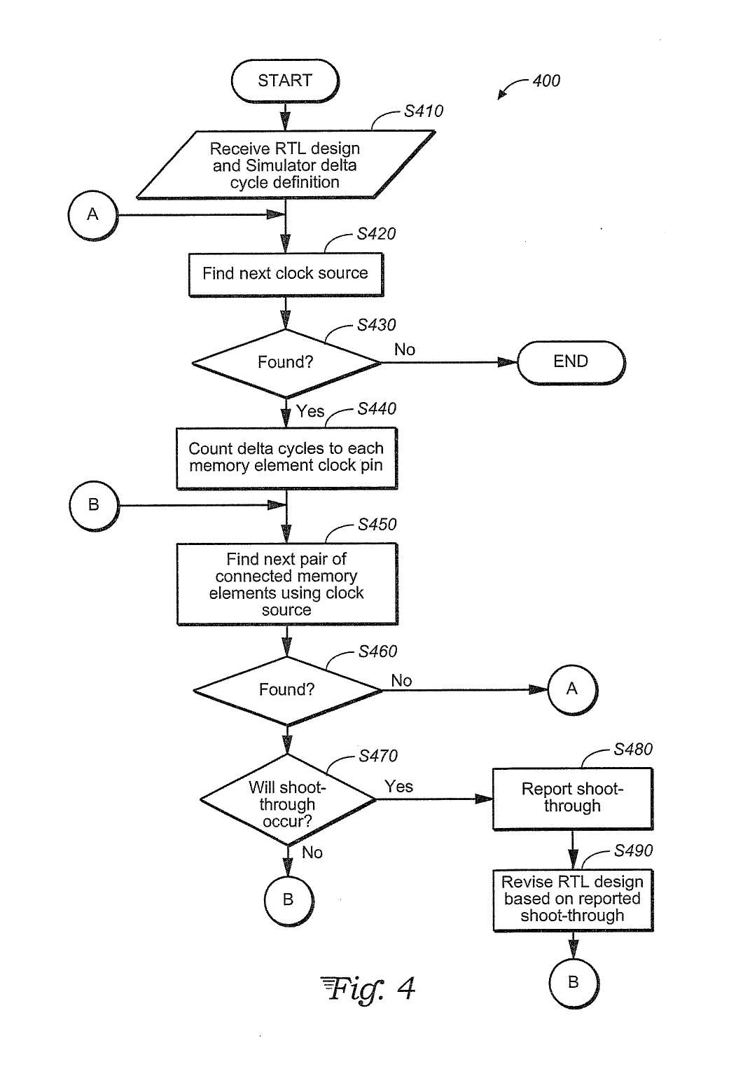

FIG. 4 is an exemplary and non-limiting flowchart 400 for checking shoot-through simulation errors. In S410 the STC receives the design RTL and a Simulator delta cycle definition. The design RTL may be written in one or hardware description languages such as VHDL or Verilog. In one embodiment parts of the design are synthesized RTL netlists. The simulator delta cycle definition indicates the conditions under which the current simulator will add delta delays. The simulator delta cycle definition has entries for different simulators, different simulator versions, different RTL languages, and the instantiation of modules of a different RTL type. In one embodiment the simulator delta cycle definition is stored in a file that is read by the STC. In a second embodiment the simulator delta cycle definition is predefined within the STC. In yet another embodiment the STC generates the simulator delta cycle definition by analyzing the simulation output of a standard RTL design.

In S420 the STC starts a loop for processing each of the clock sources in the RTL design. On the first iteration of the loop the STC looks for the first clock source. On subsequent iterations the STC looks for next unprocessed clock source. In S430 the STC checks if it found an unprocessed clock source. If the STC found an unprocessed clock source it proceeds to S440. If the STC did not find an unprocessed clock source the STC exits.

In S440 the STC calculates the delta delay cycles from the current clock source to the clock pins of connected memory elements. Memory elements include registers, latches and other synchronous elements controlled by a clock. In S450 the STC starts a loop for processing each pair of connected memory elements using the current clock source. On the first iteration of the loop the STC looks for the first pair of connected memory elements. On subsequent iterations the STC looks for the next unprocessed pair of connected memory elements. Pairs of memory elements that have same number of delta delay cycles from the clock source to their clock pin are ignored. In S460 the STC checks if it found an unprocessed pair of memory elements. If the STC found an unprocessed pair of memory elements the STC proceeds to S470. If the STC did not find an unprocessed pair of memory elements it loops back to S420.

Mux-based clock dividers need to be handled carefully to get an accurate analysis. When a clock drives a Mux-select and memory element outputs drive the Mux's data inputs, only the mux-select is considered as being in the clock path. The other mux inputs are considered as being in the data path.

In S470 the STC determines if a shoot-through simulation error will occur. If the source memory element has an explicit delay the STC concludes that no shoot-through simulation error will occur. If the clock path from a clock source to a memory element clock pin has an explicit delay the STC reports a warning and in one embodiment modifies the design to automatically remove the explicit delay. Clock paths should not use delayed assignment. An explicit delay is specified in a delayed assignment statement. The STC calculates a clock path difference, the difference in delta delays from clock source to memory element clock pin. If the delay in the source clock path is less than the delay in destination clock path, the STC determines that a shoot-through simulation error may occur. The designer who wants to balance the clock trees needs to know when the source clock path delay is less than the destination clock path delay.

The designer can specify that the STC should compare the clock path delay difference to the data path delay. This allows the designer to fix problems by changing the data path. In this case the STC calculates the delta delay on the data path between the memory elements. If the clock path delay difference is greater than the data path delay, the STC reports a shoot-through simulation error. In one embodiment the STC ignores data paths indicated by the user. The user can mark design elements to be ignored by assigning attributes in the RTL or by listing them in a special file.

In one embodiment the STC checks for a no_delay_comparison parameter. The user can apply this parameter to the entire design or to part of the design. When the no_delay_comparison parameter is set to “yes”, the STC will check the presence of a delayed assignment statement when there is non-zero delay in the destination clock path after a common clock point. The common clock point is a net which is common to both source and destination clock paths.

If in S470 the STC determines that a shoot-through simulation error will occur, the STC proceeds to S480. If the STC determines that a shoot-through simulation error will not occur the STC loops back to S450. In S480 the STC reports and in S490 corrects the expected shoot-through simulation error. In one embodiment, the STC writes the details of the shoot-through simulation error into a report. In the same or another embodiment, the STC makes a specific recommendation of changing the RTL to add a delayed assignment in the data path. Delayed assignment will prevent the simulation problem. In another embodiment, the STC automatically modifies the RTL to add a delayed assignment in the data path. The STC proceeds to loop back to S450.

The embodiments disclosed herein can be implemented as hardware, firmware, software, or any combination thereof. Moreover, the software is preferably implemented as an application program tangibly embodied on a program storage unit or computer readable medium. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit.

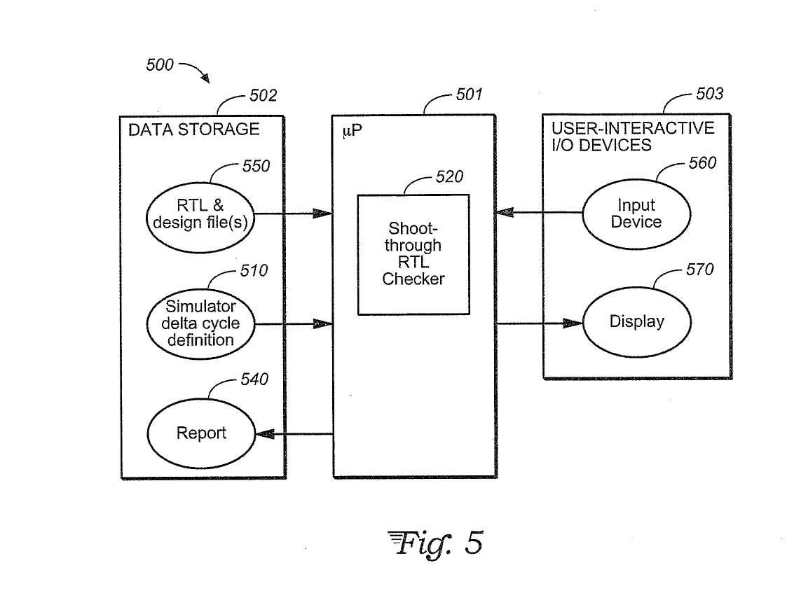

FIG. 5 is an exemplary and non-limiting diagram 500 showing a system embodying a shoot-through RTL Checker (STC) 520. A central processing unit (CPU) or microprocessor (μP) 501 loads and runs the shoot-through RTL checker software 520. A data storage 502 is accessible to the processor 501 and stores RTL design files 550 representing a circuit description and in a preferred embodiment may further store simulator delta cycle definitions 510 for a variety of simulators. A report 540 generated by the processor for display to a user, as well as corrected RTL design files could likewise be stored in the data storage 502 for use by a simulator. The system 500 further includes user-interactive input/output devices, including at least one input device 560 and display 570.

The STC 520 runs as an application program on a central processing unit (CPU). In one embodiment the STC is embedded in an application program that makes multiple checks. The STC 520 interacts with a logic designer through an input device, 560 and a display, 570. The STC 520 displays STC checking results on the display, 570. A logic designer specifies STC inputs, starts the STC and views results using the input device 560 and display 570. A logic designer views a list of shoot-through simulator issues on the display 570. In one embodiment the STC 520 reads a simulator delta cycle definition 510 from a file. The STC 520 reads RTL and/or netlist design files 550. The STC 520 reads STC run-time options from a specified file or directly from the user through input device 560. The STC run-time options include a list of paths to ignore and whether to compare clock path delay differences to the data path delay. In one embodiment the STC 520 stores the shoot-through checking results in a file as a report 540. In one embodiment, the STC 520 updates the RTL and/or netlist design files 550 to automatically correct the detected errors.

What is claimed is:

1. A method, implemented as RTL checker software running on a computer system, of checking an integrated circuit design by identifying and correcting in advance expected shoot-through behavior of a circuit simulator, comprising:
receiving, by a data storage accessible to a processor, a circuit register-transfer-level (RTL) description of at least a portion of an integrated circuit design to be run on a specified simulator;
analyzing the RTL description by the processor to determine numbers of delta delay cycles for clock and data paths of the circuit design when run on the specified simulator;
identifying, by the processor from the determined delta delay cycles and according to rules designated in the RTL checker software, any conditions in the circuit design expected to produce shoot-through behavior when run on the specified simulator;
reporting any identified conditions of expected shoot-through behavior to at least one of the data storage and to a user-interactive input/output device; and
correcting the RTL description as needed based on the reported conditions, the corrected description being saved in data storage for running on the specified simulator.

2. The method as in claim 1, wherein the delta delay cycles for clock and data paths of the circuit design are determined using delta cycle definitions of the specified simulator retrieved by the processor from the data storage.

3. The method as in claim 1, wherein identifying conditions of expected shoot-through behavior comprises identifying interacting source and destination memory elements in the circuit design, determining whether there is a difference of clock path delays between those two memory elements, and determining whether an after/# clause assignment statement specifying an explicit delay is absent in a data path of the source memory element.

4. The method as in claim 3, wherein correcting the RTL description comprises introducing the absent after/# clause assignment statement into the data path of the source memory element.

5. The method as in claim 1, wherein identifying conditions of expected shoot-through behavior comprises identifying interacting source and destination memory elements in the circuit design, determining whether an after/# clause assignment statement specifying an explicit delay is present in a clock path of either source memory element.

6. The method as in claim 5, wherein correcting the RTL description comprises removing any after/# clause assignment statement from the determined clock paths.

7. The method as in claim 1, wherein identifying conditions of expected shoot-through behavior comprises identifying interacting source and destination memory elements in the circuit design driven by a common clock point for both memory elements, and if so determining whether there is a non-zero delay for the clock path to the destination memory element that is absent in the clock path to the source memory element producing a delta delay from the common clock point.

8. The method as in claim 7, wherein correcting the RTL description comprises adding an after/# clause assignment statement specifying an explicit delay corresponding to the non-zero delay to the clock path for the destination memory element.

9. The method as in claim 1, wherein identifying conditions of expected shoot-through behavior comprises identifying memory elements in the circuit design that are connected to an output port and determining whether an after/# clause assignment statement specifying an explicit delay is absent in a data path of that memory element.

10. The method as in claim 9, wherein correcting the RTL description comprises adding the absent after/# clause assignment statement to the data path of that identified memory element.

11. The method as in claim 1, wherein identifying conditions of expected shoot-through behavior comprises ignoring instances wherever a user has specified that a data path should not be checked.

12. The method as in claim 1, wherein correcting the RTL description is performed automatically by the processor in response to identifying a condition of expected shoot-through behavior.

13. The method as in claim 12, wherein the automatic correction is displayed on the user-interactive input/output device for confirmation or rejection by a user.

14. An integrated circuit design checking system for identifying and correcting in advance expected shoot-through behavior of a circuit simulator, the system comprising a computer processor having access to data storage and user-interactive input/output devices, the data storage storing RTL checker software and simulator delta cycle definitions corresponding to one or more circuit simulators, wherein the RTL checker software, when executed by the computer processor, is operative to:
receive a circuit register-transfer-level (RTL) description of at least a portion of an integrated circuit design to be run on a specified simulator;
analyze the RTL description by the processor to determine numbers of delta delay cycles for clock and data paths of the circuit design when run on the specified simulator;
identify by the processor, from the determined delta delay cycles and according to rules designated in the RTL checker software, any conditions in the circuit design expected to produce shoot-through behavior when run on the specified simulator;
report any identified conditions of expected shoot-through behavior to at least one of the data storage and the user-interactive input/output devices; and
correct the RTL description as needed based on the reported conditions.

15. The system as in claim 14, wherein the delta delay cycles for clock and data paths of the circuit design are determined using delta cycle definitions of the specified simulator retrieved by the processor from the data storage.

16. The system as in claim 14, wherein identifying by the processor of conditions of expected shoot-through behavior comprises identifying interacting source and destination memory elements in the circuit design, determining whether there is a difference of clock path delays between those two memory elements, and determining whether an after/# clause assignment statement specifying an explicit delay is absent in a data path of the source memory element.

17. The system as in claim 16, wherein correcting the RTL description comprises introducing the absent after/# clause assignment statement into the data path of the source memory element.

18. The system as in claim 14, wherein identifying by the processor of conditions of expected shoot-through behavior comprises identifying interacting source and destination memory elements in the circuit design, determining whether an after/# clause assignment statement specifying an explicit delay is present in a clock path of either source memory element.

19. The system as in claim 18, wherein correcting the RTL description comprises removing any after/# clause assignment statement from the determined clock paths.

20. The system as in claim 14, wherein identifying by the processor of conditions of expected shoot-through behavior comprises identifying interacting source and destination memory elements in the circuit design driven from a common clock point for both memory elements, and if so determining whether there is a non-zero delay for the clock path to the destination memory element that is absent in the clock path to the source memory element producing a delta delay from the common clock point.

21. The system as in claim 20, wherein correcting the RTL description comprises adding an after/# clause assignment statement specifying an explicit delay corresponding to the non-zero delay to the clock path for the destination memory element.

22. The system as in claim 14, wherein identifying by , the processor of conditions of expected shoot-through behavior comprises identifying memory elements in the circuit design that are connected to an output port and determining whether an after/# clause assignment statement specifying an explicit delay is absent in a data path of that memory element.

23. The system as in claim 22, wherein correcting the RTL description comprises adding the absent after/# clause assignment statement to the data path of that identified memory element.

24. The system as in claim 14, wherein identifying by the processor of conditions of expected shoot-through behavior comprises ignoring instances wherever a user has specified that a data path should not be checked.

25. The system as in claim 14, wherein correcting the RTL description is performed automatically by the processor in response to identifying a condition of expected shoot-through behavior.

26. The method as in claim 25, wherein the automatic correction is displayed on the user-interactive input/output device for confirmation or rejection by a user.
